(19) United States
(12) Patent Application Publication
(10) Pub. No.: US 2015/0229111 A1
(43) Pub. Date: Aug. 13, 2015

(54) METHOD AND STRUCTURE FOR FASTENING AND ELECTRICALLY ISOLATING BUSBARS INSULATED WITH HEAT-SHRINK MATERIAL

(71) Applicant: ABB Technology AG, Zurich (CH)

(72) Inventors: Zdenek Kutalek, Brno-Kohoutovice (CZ); Stefano Motta, Besana Brianza (MB) (IT); Amar G. Kini, Lake Mary, FL (US); Frantisek Koudelka, Modrice (CZ)

(73) Assignee: ABB Technology AG, Zurich (CH)

(21) Appl. No.: 14/176,174

(22) Filed: Feb. 10, 2014

(51) Int. Cl. H02G 3/30; H02G 5/00

(52) U.S. Cl. CPC H02G 3/24; H02G 5/00

(57) ABSTRACT

Isolation structure is provided for electrically isolating a busbar mounted to a post insulator by a fastener via a busbar mounting hole. The busbar has insulating material covering the busbar except for surfaces defining the mounting hole. The isolation structure includes an electrically insulating sleeve constructed and arranged to be disposed around a portion of a periphery of the fastener and to be received in the busbar mounting hole. At least first and second electrically insulating washers each have a bore that receives the insulating sleeve. The insulating washers are constructed and arranged to engage with the surfaces defining the mounting hole on opposing sides of the busbar so as to sandwich the busbar between the first and second insulating washers.

### FIELD

The invention relates to medium voltage air insulated switchgears and, more particularly, to a method and structure for fastening and electrically isolating busbars that are insulated with heat-shrink material.

### BACKGROUND

It is known from the art that air-insulated high and medium-voltage electric stations use a system of busbars. Each busbar is preferably covered in heat-shrink material and appropriately connected to a main electric power supply line and to a power transformer.

With reference to FIG. 1, a mounting hole 10 or slot is punched in the conventional copper busbar 12 prior to the heat-shrink process. Heat shrink material 14 such as tubing is slid over the busbar 12 and heated to shrink the tubing tightly to the busbar 14. The heat-shrink material that covers the mounting hole 10 is cut away for installation access. This leaves the hole 10 uninsulated, and portions 15 of the busbars 12 exposed, requiring the need for a taller post insulator 17 and more space to provide adequate creepage and clearance distances.

Thus, there is a need to provide proper electrical insulation of a busbar without damaging the heat-shrink material.

### SUMMARY

An objective of the invention is to fulfill the need referred to above. In accordance with the principles of the present invention, this objective is obtained by providing isolation structure for electrically isolating a busbar mounted to a post insulator by a fastener via a busbar mounting hole. The busbar has insulating material covering the busbar except for surfaces defining the mounting hole. The isolation structure includes an electrically insulating sleeve constructed and arranged to be disposed around a portion of a periphery of the fastener and to be received in the busbar mounting hole. At least first and second electrically insulating washers are provided, each having a bore that receives the insulating sleeve. The insulating washers are constructed and arranged to engage with the surfaces defining the mounting hole on opposing sides of the busbar so as to sandwich the busbar between the first and second insulating washers.

In accordance with another aspect of the disclosed embodiment, a method is provided for electrically isolating a busbar when fastened to a post insulator. The busbar has a mounting hole and insulating material covering the busbar except for surfaces defining the mounting hole. The method provides a fastener having a head at one end thereof. An insulating sleeve is placed around a portion of a periphery of the fastener. The sleeve is provided through the mounting hole of the busbar and through a bore in at least a first and a second insulating washer so that the insulating washers engage the surfaces defining the mounting hole on opposing sides of the busbar, thereby sandwiching the busbar between the first and second insulating washers. The fastener is secured to the post insulator.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a side sectional view of a conventional copper busbars with heat-shrink tubing cut away from the mounting holes in the busbars.

FIG. 2 is sectional view of isolating structure in accordance with an embodiment used in fastening and electrically isolating busbars, which are insulated with heat-shrink material, to a post insulator via a fastener.

FIG. 3 is a sectional view of isolating structure in accordance with another embodiment used in fastening and electrically isolating busbars that are insulated in epoxy.

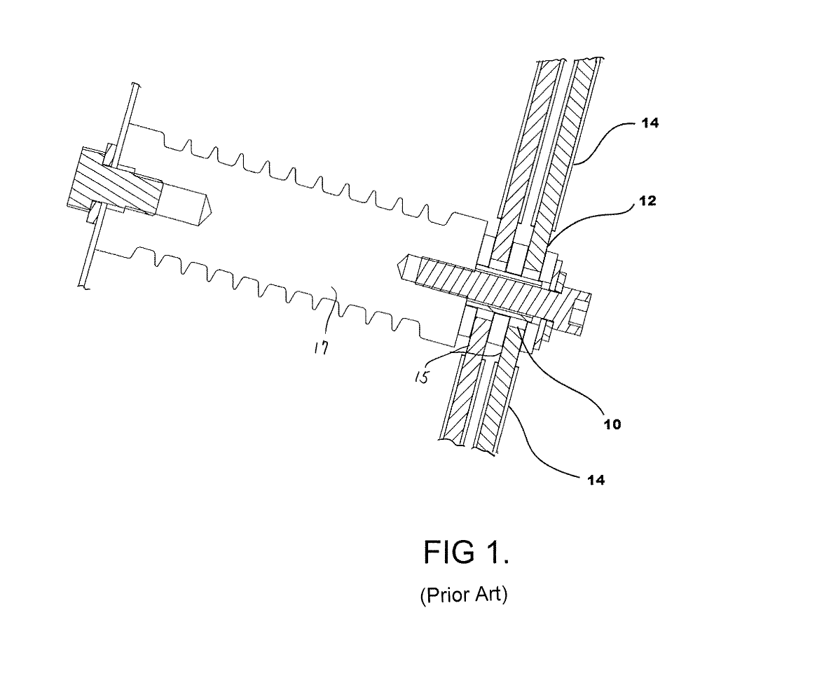

### DETAILED DESCRIPTION OF AN EXEMPLARY EMBODIMENT

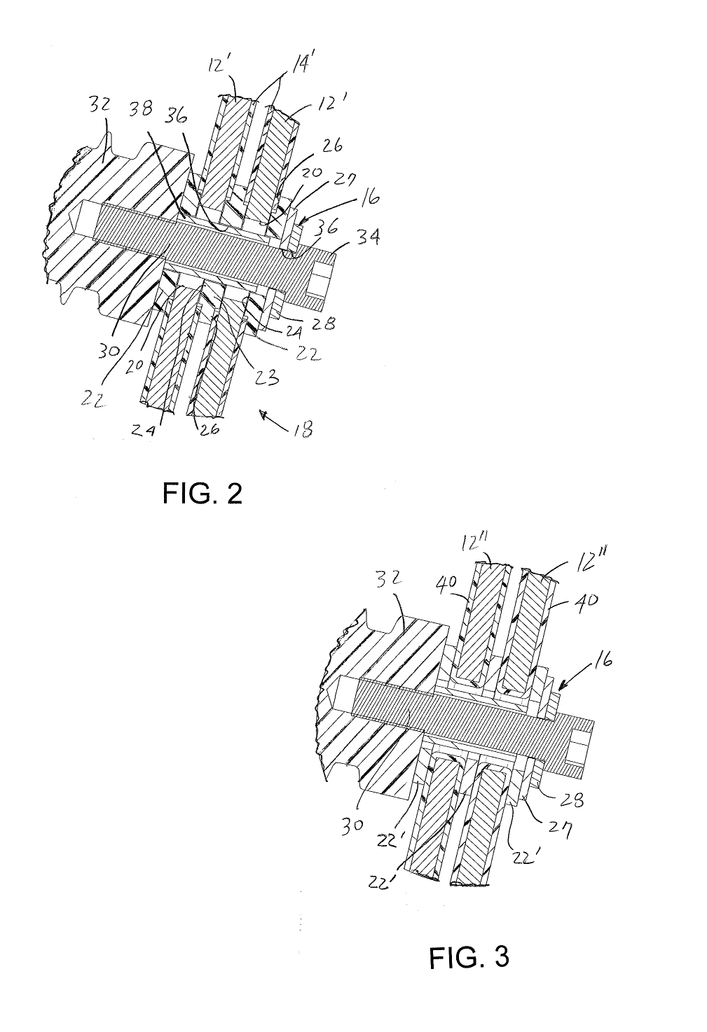

With reference to FIG. 2, isolating structure is shown, generally indicated at 16, in accordance with an embodiment. The isolating structure 16 is used to fasten and electrically isolate copper busbars 12′, insulated with heat-shrink insulating material 14′ in a medium voltage, air insulated switchgear, a portion of which is shown generally indicated at 18. As used herein “heat-shrink insulating material” can be, for example, in tubular form that is received over a busbar or may be a tape that wrapped around the busbar and heated to shrink the material around the busbar.

As shown in FIG. 2, a mounting hole 20 of each busbar 12′ is free of the heat-shrink insulating material 14′. An electrically insulating washer 22 and 23 is engaged with surfaces defining the exposed mounting hole 20 of each busbar 12′ and disposed on opposing sides of each busbar 12′ so as to sandwich each busbar 12′ between the two washers 22 and 23. The washers 22 and 23 are preferably made of conventional glass polyester resin to electrically isolate the busbars 12′. Each washer 22 and 23 has a first planar surface 24 that engages the surfaces defining the exposed mounting hole 20 of the busbar 12′, and a second planar surface 26 that engages the heat-shrink insulating material 14′. The second planar surface 26 is spaced from the first planar surface 24 a distance generally equal to the thickness of the heat-shrink material 14′. The second planar surface 26 defines a flange that presses against the heat-shrink insulating material 14′ to prevent air gaps and maintain electrical isolation at the mounting hole location. The flange height is configured to limit the amount of compression on the heat shrink insulating material 14′. It is noted that center washer 23 has a second surface flange 26 on opposing sides thereof while washers 22 each has only one second surface flange 26.

A flat washer 27 is preferably provided between the proximal insulating washer 22 and a spring washer 28. A mounting fastener such as a screw 30 couples the busbars 12′ to a post insulator 32 since the mounting screw 30 is in threaded engagement with the post insulator 32. A head 34 of the screw 30 thus clamps on the spring washer 28, with the spring washer 28 maintaining sufficient clamping force on the flat washer 28, insulating washers 22 and 23 and busbars 12′ during thermal expansion thereof.

Each washer 22, 23, 26, 28 is of disk shape have a central bore 36 therethrough, receiving the screw 30 and an electrically insulating sleeve 38 disposed over a portion of the periphery of the screw 30. The sleeve 38 is received in busbar mounting holes 20 and electrically isolates the mounting screw 30 from the busbars 12′. The sleeve 38 is preferably of a heat-shrink material such as any conventional insulating material.

The use of flanged washers 22 and 23 provides proper electrical isolation of busbars 12′ without damaging the heat-shrink insulating material 14′. With the isolation structure 16 of the embodiment, a shorter post insulator 32 can be used, as compared to the conventional one, because this mounting method provides adequate sealing to meet operational creepage and clearance requirements, saving space and busbar material. In addition, with reference to FIG. 3 busbars 12″ that are insulated with epoxy 40 can be mounted in place of heat-shrink busbars 12′ without changing dimensions of either the busbar or the mounting location. In this embodiment, flat washers (non-flanged) 22′ replace the washers 22 and 23 of FIG. 2.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. Isolation structure for electrically isolating a busbar mounted to a post insulator by a fastener via a busbar mounting hole, the busbar having insulating material covering the busbar except for surfaces defining the mounting hole, the isolation structure comprising:
an electrically insulating sleeve constructed and arranged to be disposed around a portion of a periphery of the fastener and to be received in the busbar mounting hole, and
at least first and second electrically insulating washers, each having a bore that receives the insulating sleeve, the insulating washers being constructed and arranged to engage with the surfaces defining the mounting hole on opposing sides of the busbar so as to sandwich the busbar between the first and second insulating washers.

2. The isolation structure of claim 1, wherein the insulating washers are made of glass polyester resin and the sleeve includes a heat-shrink material.

3. The isolation structure of claim 1, further comprising a spring washer having a bore that receives the insulating sleeve and being constructed and arranged to be disposed between a head of the fastener and one of the insulating washers.

4. The isolation structure of claim 3, further comprising a flat washer having a bore that receives the insulating sleeve and being constructed and arranged to be disposed between the one insulating washer and the spring washer.

5. The isolation structure of claim 1, wherein each isolating washer has a first planar surface constructed and arranged to engage the surfaces defining the mounting hole of the busbar and a second planar surface constructed and arranged to engage the insulating material.

6. The isolation structure of claim 5, wherein the second planar surface defines a flange that is spaced from the first planar surface, the flange being constructed and arranged to press against the insulating material to prevent air gaps and maintain electrical isolation at the mounting hole.

7. The isolation structure of claim 1, in combination with the busbar, fastener and post insulator, the sleeve being disposed about the portion of the fastener and the insulating washers being engaged with the surfaces defining the mounting hole on the opposing sides of the busbar.

8. The combination of claim 7, further comprising a spring washer having a bore that receives the insulating sleeve and disposed between a head of the fastener and one of the insulating washers.

9. The combination of claim 8, further comprising a flat washer having a bore that receives the insulating sleeve and disposed between the one insulating washer and the spring washer.

10. The combination of claim 7, wherein each insolating washer has a first planar surface engaging the surfaces defining the mounting hole of the busbar and a second planar surface engaging the insulating material.

11. The combination of claim 10, wherein the second planar surface defines a flange that is spaced from the first planar surface, the flange pressing against the insulating material to prevent air gaps and maintain electrical isolation at the mounting hole.

12. The combination of claim 11, wherein the insulating material is heat-shrink insulating material.

13. A method of electrically isolating a busbar when fastened to a post insulator, the busbar having a mounting hole and having insulating material covering the busbar except for surfaces defining the mounting hole, the method comprising the steps of:
providing a fastener having a head at one end thereof,
placing an insulating sleeve around a portion of a periphery of the fastener,
providing the sleeve through the mounting hole of the busbar and through a bore in at least a first and a second insulating washer, so that the insulating washers engage the surfaces defining the mounting hole on opposing sides of the busbar, thereby sandwiching the busbar between the first and second insulating washers, and
securing the fastener to the post insulator.

14. The method of claim 13, wherein before the securing step, the method provides a spring washer over the periphery of the fastener so as to be between one of the insulating washers and the head of the fastener.

15. The method of claim 14, further comprising providing a flat washer, having a bore that receives the insulating sleeve, between the one insulating washer and the spring washer.

16. The method of claim 14, wherein each insulating washer has a first planar surface engaging the surfaces defining the mounting hole of the busbar and a second planar surface engaging the insulating material.

17. The method of claim 16, wherein the second planar surface defines a flange that is spaced from the first planar surface, the method including pressing the flange against the insulating material to prevent air gaps and maintain electrical isolation at the mounting hole.

18. The method of claim 13, wherein the insulating material is heat-shrink insulating material.
